(19) United States
(12) Patent Application Publication
(10) Pub. No.: US 2004/0187334 A1
(43) Pub. Date: Sep. 30, 2004

(54) Railroad track design template(2)

(76) Inventor: John W. P. Redden, Leavenworth, KS (US)

Correspondence Address: John W. P. Redden, P.E., 24170 131st Street, Leavenworth, KS, 66048, US

(21) Appl. No.: 10/395,760

(22) Filed: Mar. 25, 2003

(51) Int. Cl. B43L 7/00

(52) U.S. Cl. 33/566

(57) ABSTRACT

My railroad design templates depict a turnout of a given size by its exact frog angle so that the centerline of the diverging side of the turnout can be accurately drawn from the turnout point of intersection (TOPI). This methodology of using a template to depict a turnout of a given size by its exact frog angle has never been done before and should assist railroad track designers during the design of preliminary track layouts on a drawing. My railroad design templates also combine all the various degree of curves, various size turnouts, various scales and protractor all on one template. This unique combination of various track design elements on a template has never been accomplished before and should be a convenience to railroad track designers. My railroad design templates also allow the track designer to indicate the point of switch (PS) and last-long tie (LLT) locations on their drawings. I believe the depiction of the point of switch and last-long-tie locations of a turnout on a drawing via a template has never been done before and should be a convenience to railroad track designers.

My invention is the development of two (2) railroad track design template(s) that function as convenient design aids and drafting tools for designers and engineers. These templates facilitate the development of conceptual track layouts and preliminary alignments. The first railroad design template is entitled Trak-Edge F/P and is for use in the design of freight and passenger track alignments. The second railroad design template is entitled Trak-Edge R/T and is for use in the design of light rail and transit track alignments.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

The field of endeavor that my invention may benefit is in the railroad track alignment branch of Civil Engineering design. Engineers and designers depict track alignments on construction drawings by showing only the centerline of the track or turnout. Plastic “railroad curve boards” have been used for years and are still used today to design the centerline of curved track alignments. These “railroad curve boards” are often employed to draw the approximate curvature of a specific size turnout. A turnout is an arrangement of movable and fixed rails that divert or switch the train from the straight track to the diverging track. However, the use of railroad curve boards is not an accurate method to draw the centerline of the diverging side of a turnout. Turnouts come in different sizes based on its deflection (frog) angle and length. The appropriate size of a turnout size is selected by the designer based on the desired train speed through the diverging side of the turnout. Low numbered turnouts have relatively larger frog angles, are relatively shorter and are used for slow speed train movements whereas higher numbered turnouts have relatively smaller frog angles, are relatively longer and are used for high speed train movements. The problem is that each Railroad has its own design standard for a turnout of a given size resulting in varying curvature from railroad to railroad for a specific size turnout. In addition, the curvature of a given size turnout will vary depending upon whether straight or curves switch points are used in the turnout. The only design characteristic that is consistent from turnout to turnout of a given size is the frog angle. In other words, the frog angle (5 degrees, 43 seconds, 29 minutes) of a Union Pacific NO. 10 turnout is exactly the same as the frog angle of a Norfolk Southern NO. 10 turnout even though other properties of the turnouts may vary.

### BRIEF SUMMARY OF THE INVENTION

My railroad design templates overcome the problems associated with varying standards by depicting a turnout of a given size by its exact frog angle so that the diverging side of the turnout can be accurately drawn. Using a template to depict a turnout of a given size by its exact frog angle has never been done before and should assist railroad track designers during the conceptual track alignment process.

Combining all the various size curves, various size turnouts, various scales and protractor on my railroad design templates has never been done before and should assist railroad track designers.

The Trak-Edge F/P (freight and passenger) and Trak-Edge R/T (rail transit) templates are convenient railroad design tools that will facilitate the accurate development of conceptual track layouts and preliminary alignments in the freight and passinger and light rail and transit sectors respectively of track engineering. An experienced track designer can use these Trak-Edge templates to plan and layout new yards, terminals, connections, passing sidings, cross-overs, and industry sidings. The trak-Edge templates can also bridge the communication gap between the experienced track designer who has little if any CADD (computer aided drafting & design) skills and the proficient CADD technician who has minimal experience in track design. The Trak-Edge templates can be used with new survey information to develop the expansion or reconfiguration of existing yards. The Trak-Edge templates can also be used to generate preliminary track layouts from existing drawings that are not available in electronic format. The Trak-Edge templates, in the hands of an experienced track engineer, can streamline the development of preliminary track layouts for management approval and facilitate the development of construction quantities and estimates for budget purposes.

### BRIEF DESCRIPTION OF SEVERAL VIEWS OF THE DRAWING

FIG. 1 shows the top view of the Trak-Edge F/P (freight and passenger) template without text. The drawing is reduced such that the scale is 1 inch on the drawing=2 inches on the actual template. FIG. 1 also is the Key Plan that explains the orientation of FIGS. 1A, 1B, 1C and 1D.

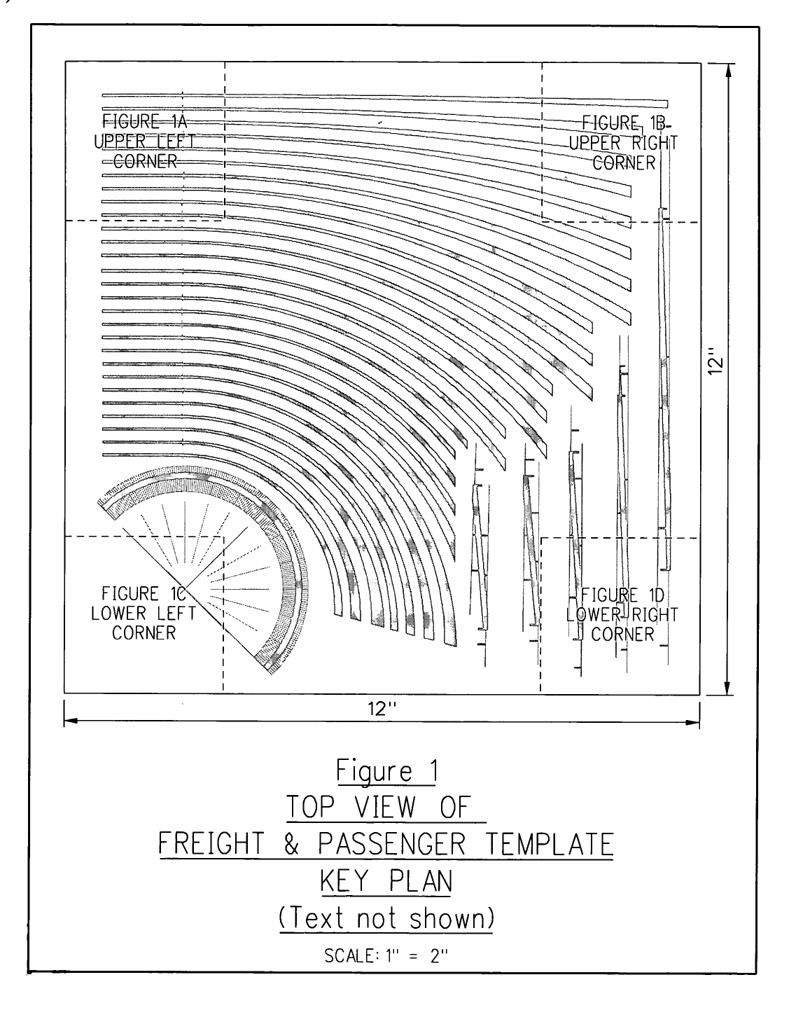

FIG. 1A is an enlargement of the upper left corner of the top view of the Trak-Edge F/P template. The scale is 1 inch on the drawing=½ inches on the actual template.

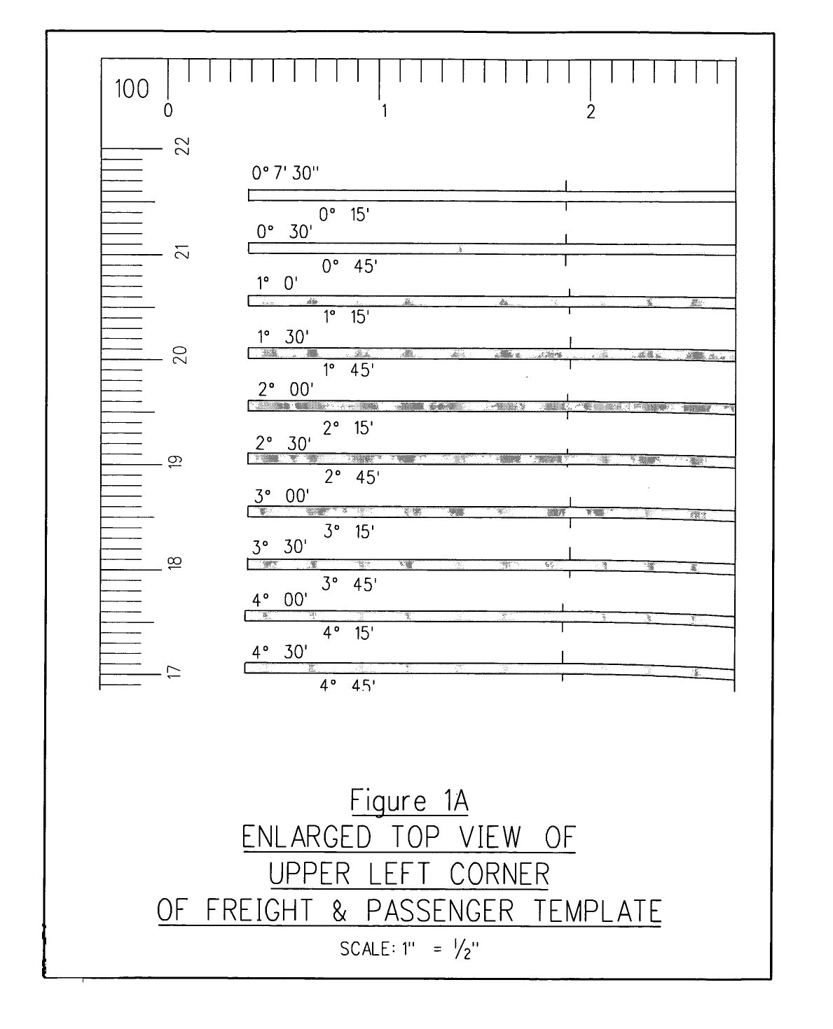

FIG. 1B is an enlargement of the upper right corner of the top view of the Trak-Edge F/P template. The scale is 1 inch on the drawing=½ inches on the actual template.

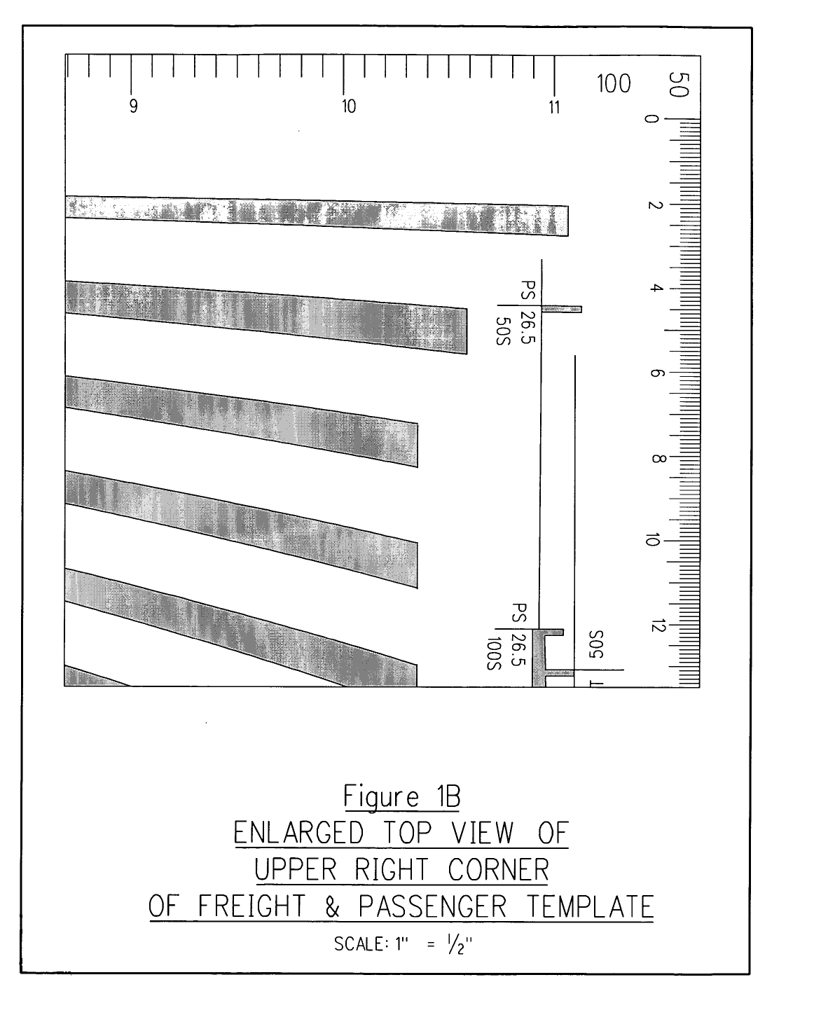

FIG. 1C is an enlargement of the lower left corner of the top view of the Trak-Edge F/P template. The scale is 1 inch on the drawing=½ inches on the actual template.

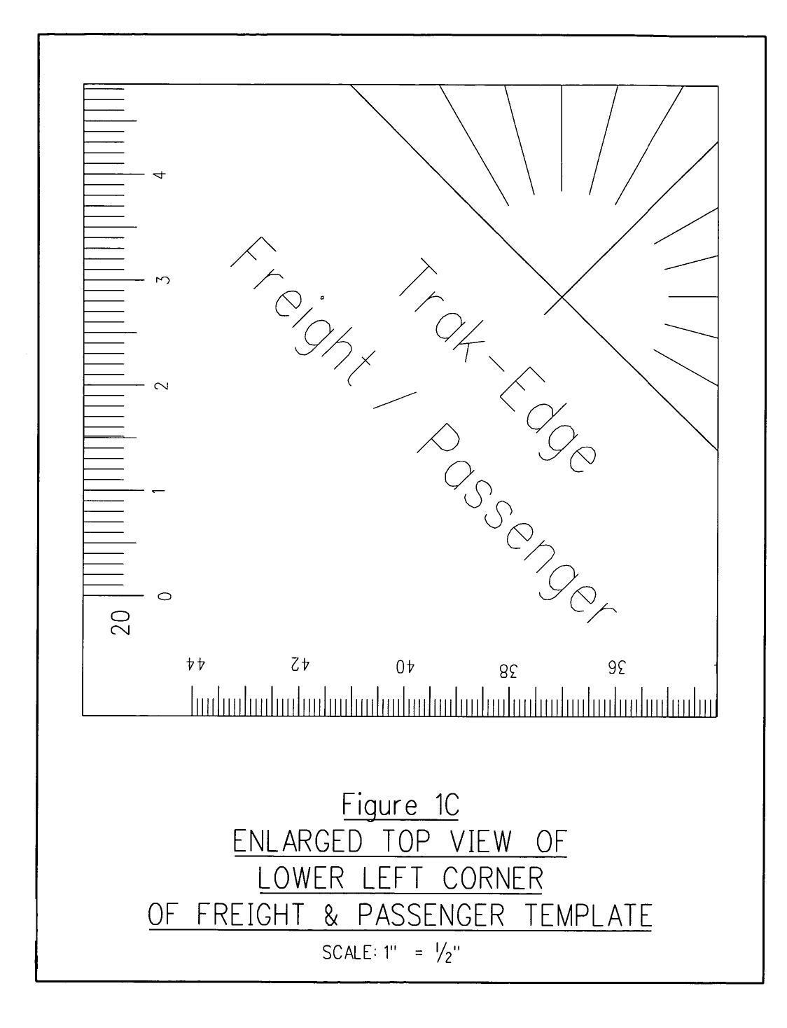

FIG. 1D is an enlargement of the lower right corner of the top view of the Trak-Edge F/P template. The scale is 1 inch on the drawing=½ inches on the actual template.

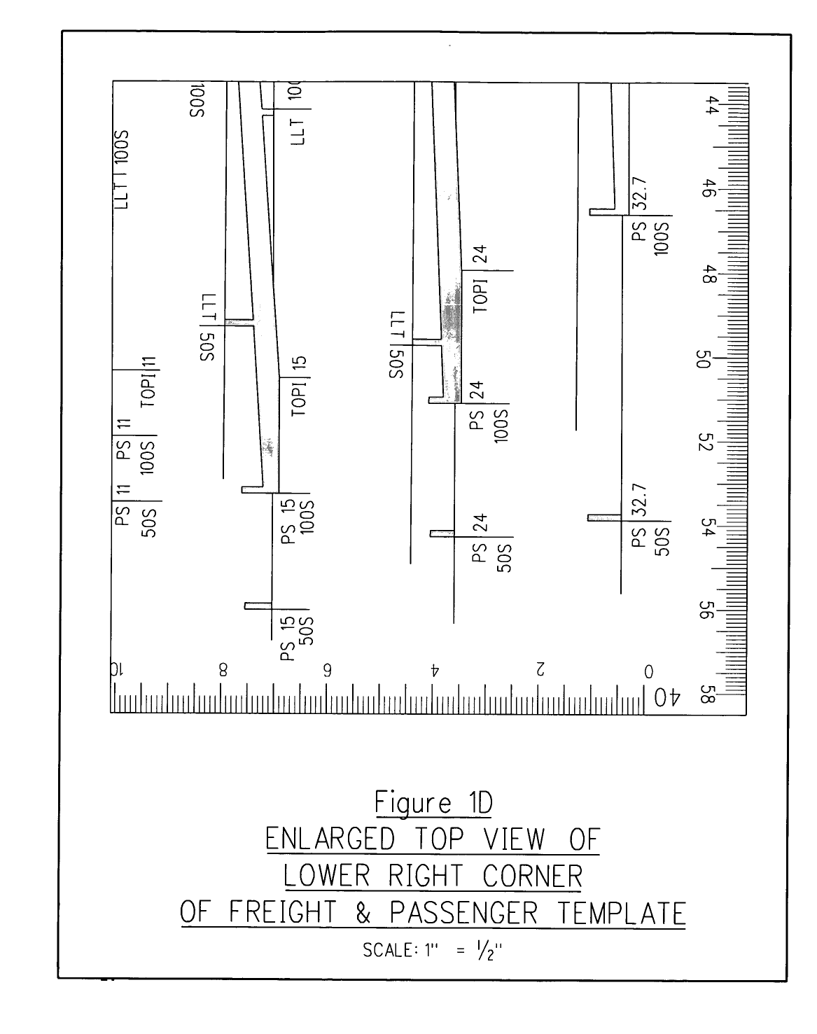

FIG. 2 shows the bottom view of the Trak-Edge F/P template without text. The drawing is reduced such that the scale is 1 inch on the drawing=2 inches on the actual template. FIG. 2 also is the Key Plan that explains the orientation of FIGS. 2A, 2B, 2C and 2D.

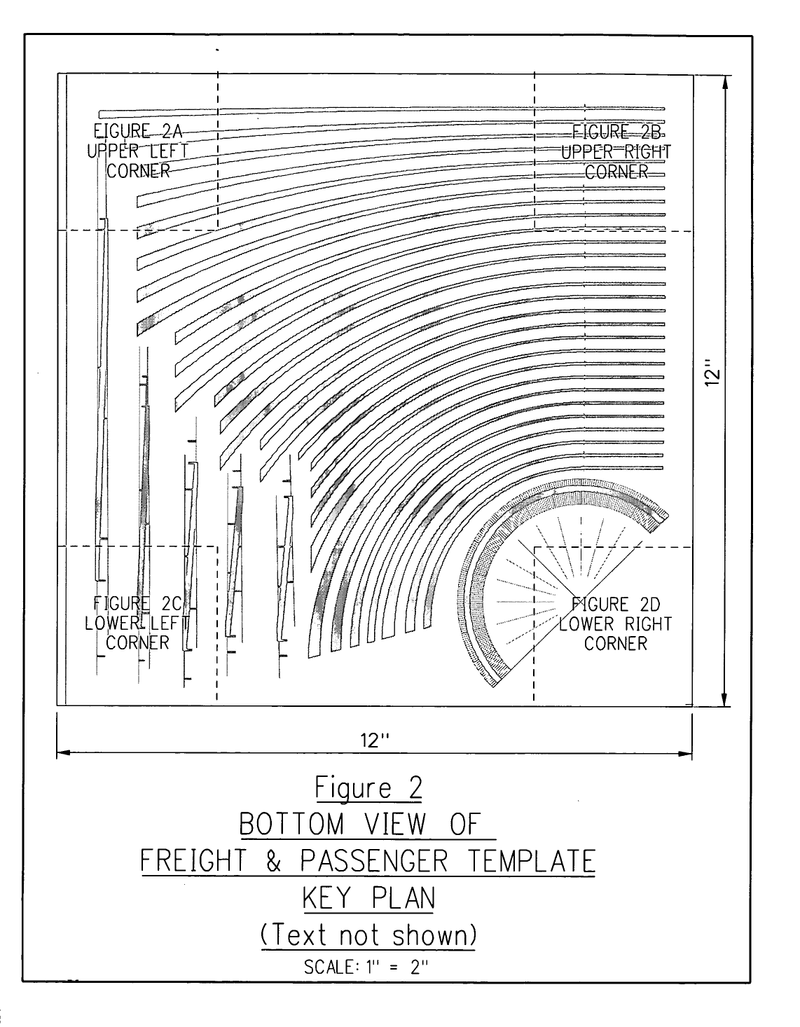

FIG. 2A is an enlargement of the upper left corner of the bottom view of the Trak-Edge F/P template. The scale is 1 inch on the drawing=½ inches on the actual template.

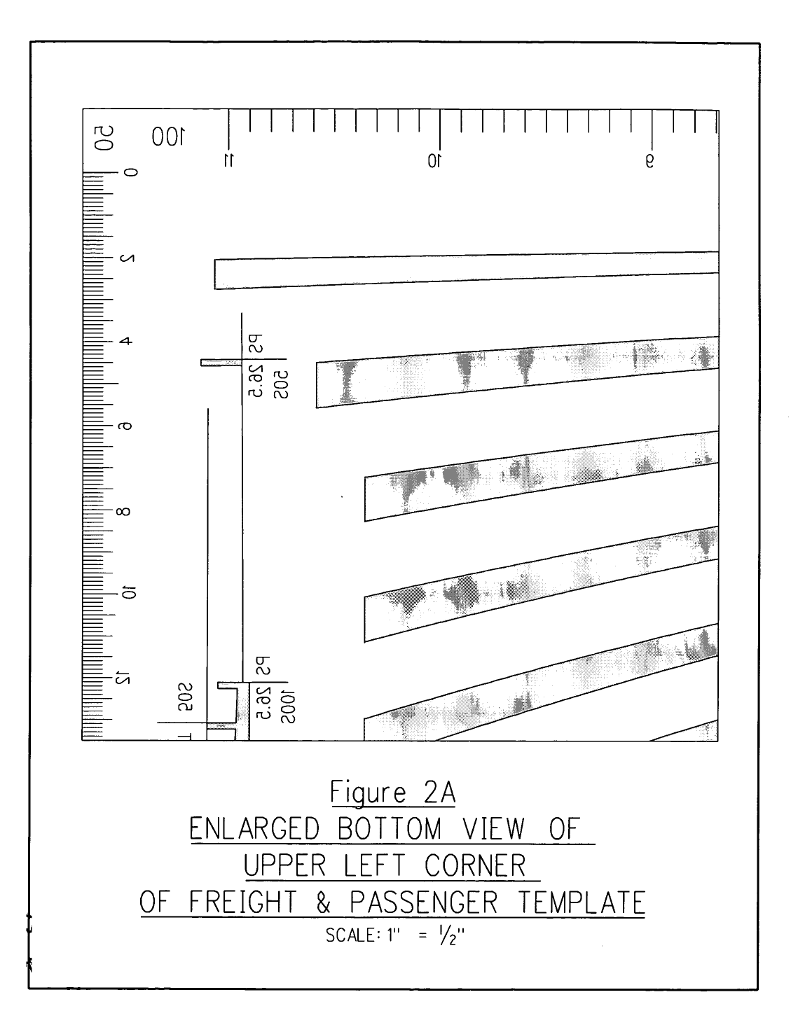

FIG. 2B is an enlargement of the upper right corner of the bottom view of the Trak-Edge F/P template. The scale is 1 inch on the drawing=½ inches on the actual template.

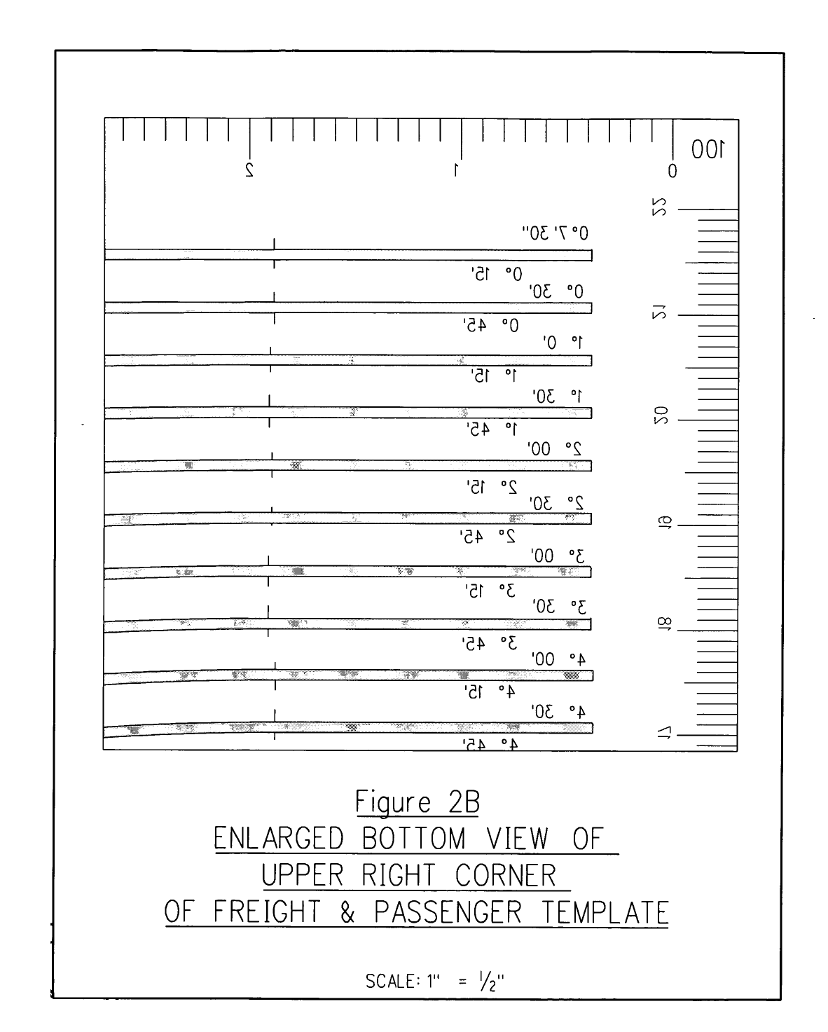

FIG. 2C is an enlargement of the lower left corner of the bottom view of the Trak-Edge F/P template. The scale is 1 inch on the drawing=½ inches on the actual template.

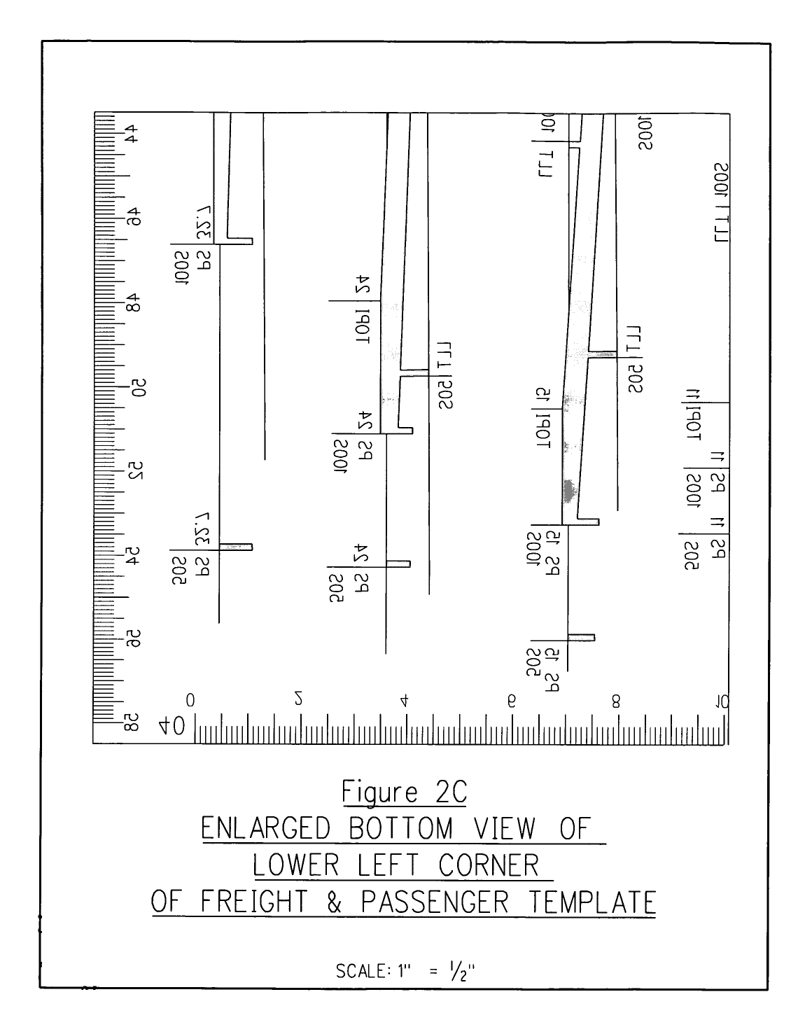

FIG. 2D is an enlargement of the lower right corner of the bottom view of the Trak-Edge F/P template. The scale is 1 inch on the drawing=½ inches on the actual template.

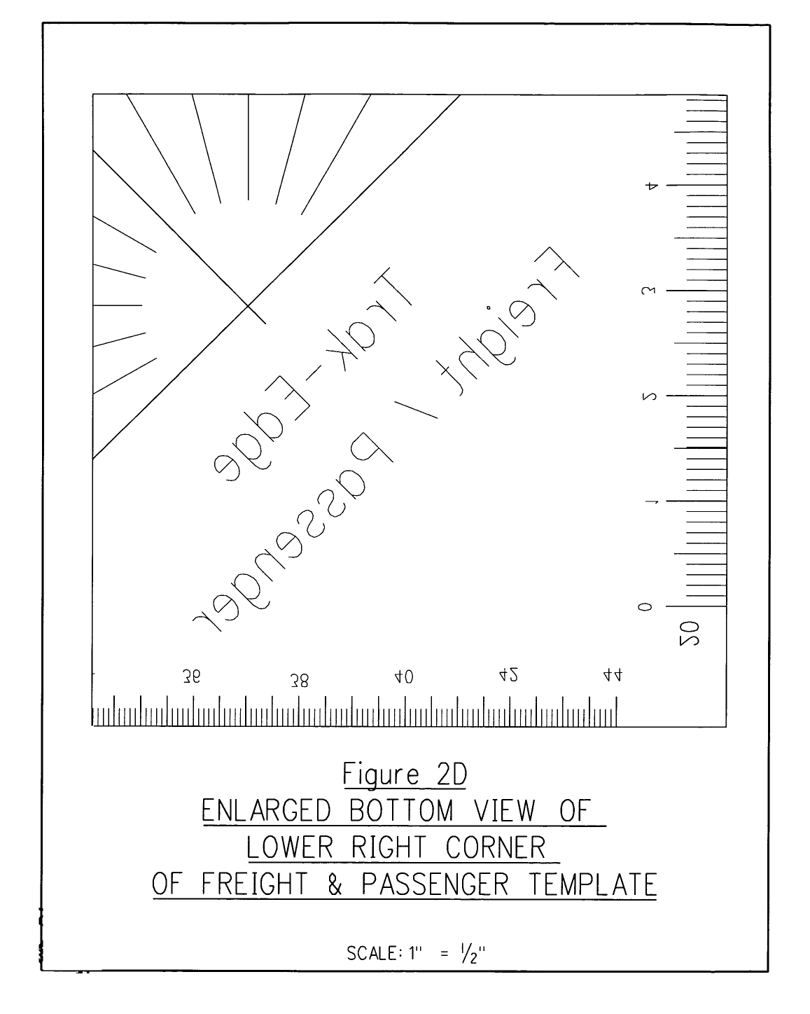

FIG. 3 shows the side view of the Trak-Edge Freight & Passenger and Trak-Edge Rail Transit templates. The drawing is reduced such that the scale is 1 inch on the drawing=2 inches on the actual template.

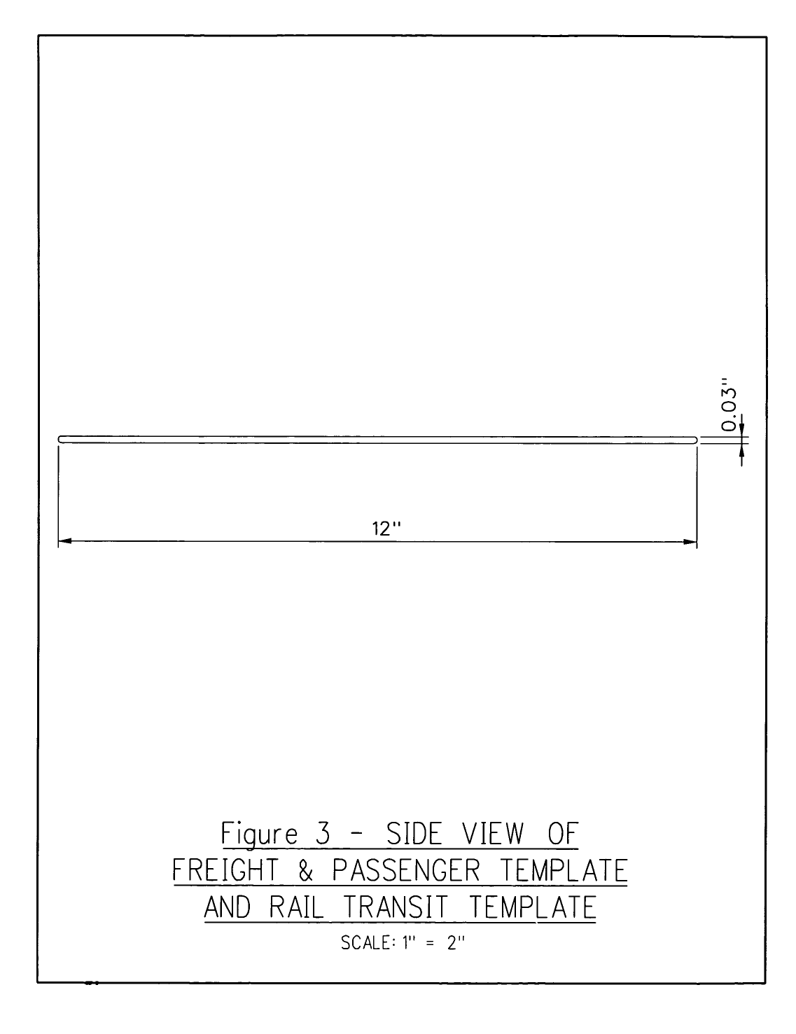

FIG. 4 shows the top view of the Trak-Edge R/T (rail transit) template without text. The drawing is reduced such that the scale is 1 inch on the drawing=2 inches on the actual template. FIG. 4 also is the Key Plan that explains the orientation of FIGS. 4A, 4B, 4C and 4D.

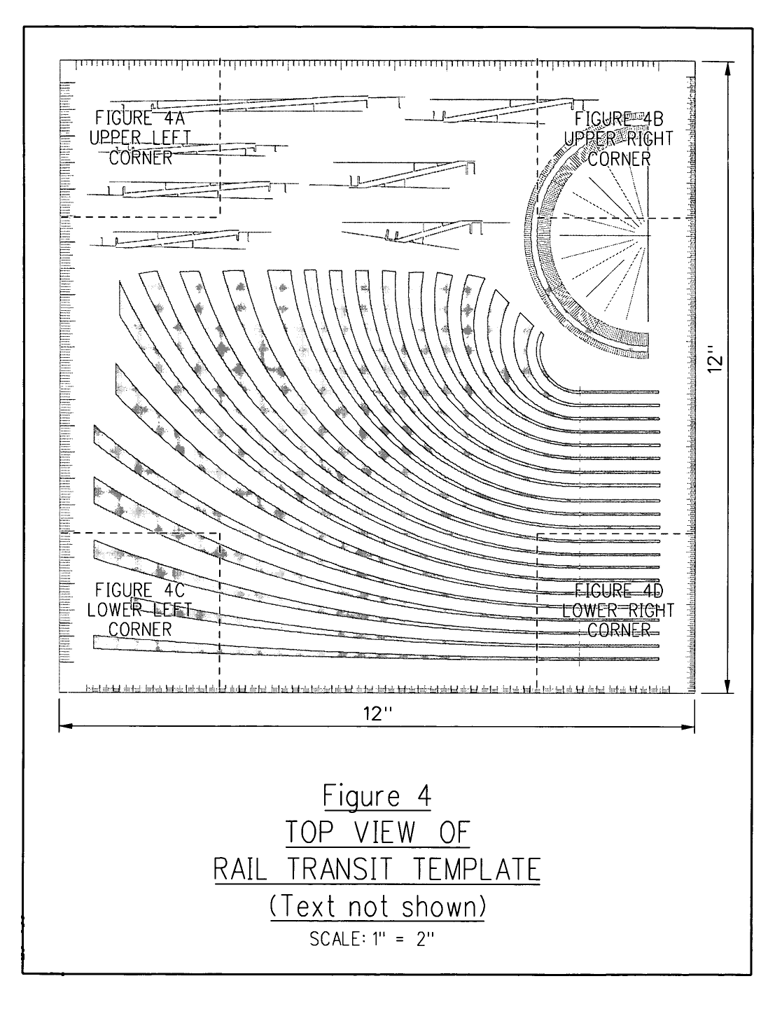

FIG. 4A is an enlargement of the upper left corner of the top view of the Trak-Edge R/T template. The scale is 1 inch on the drawing=½ inches on the actual template.

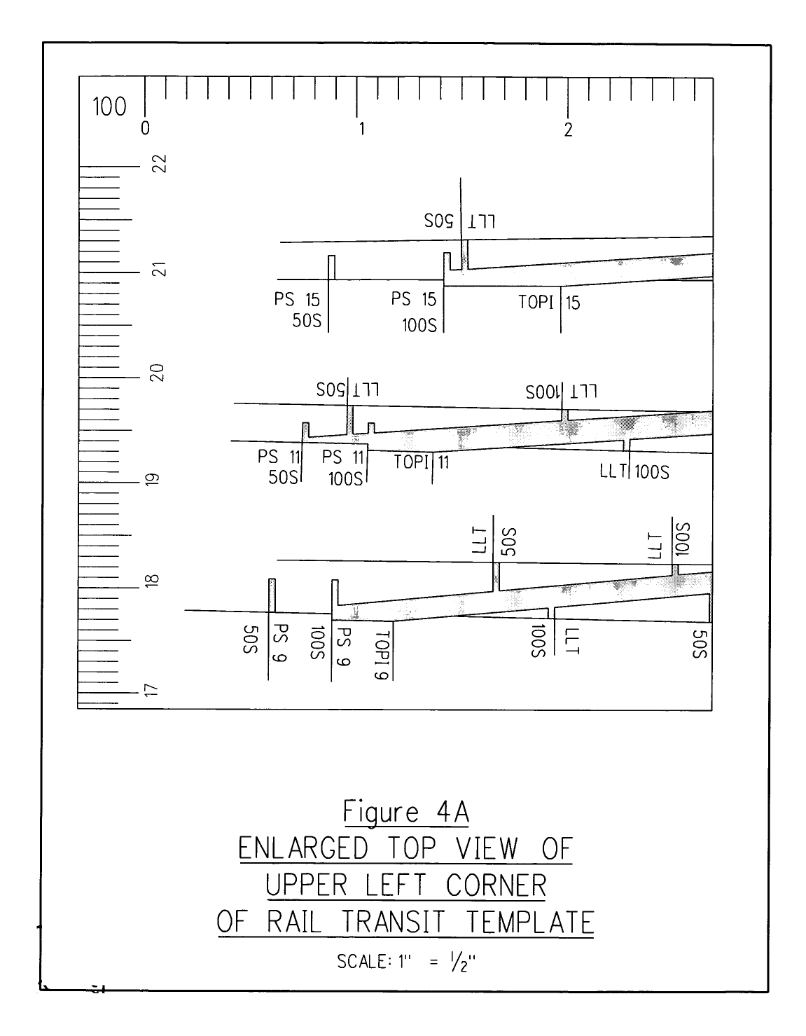

FIG. 4B is an enlargement of the upper right corner of the top view of the Trak-Edge R/T template. The scale is 1 inch on the drawing=½ inches on the actual template.

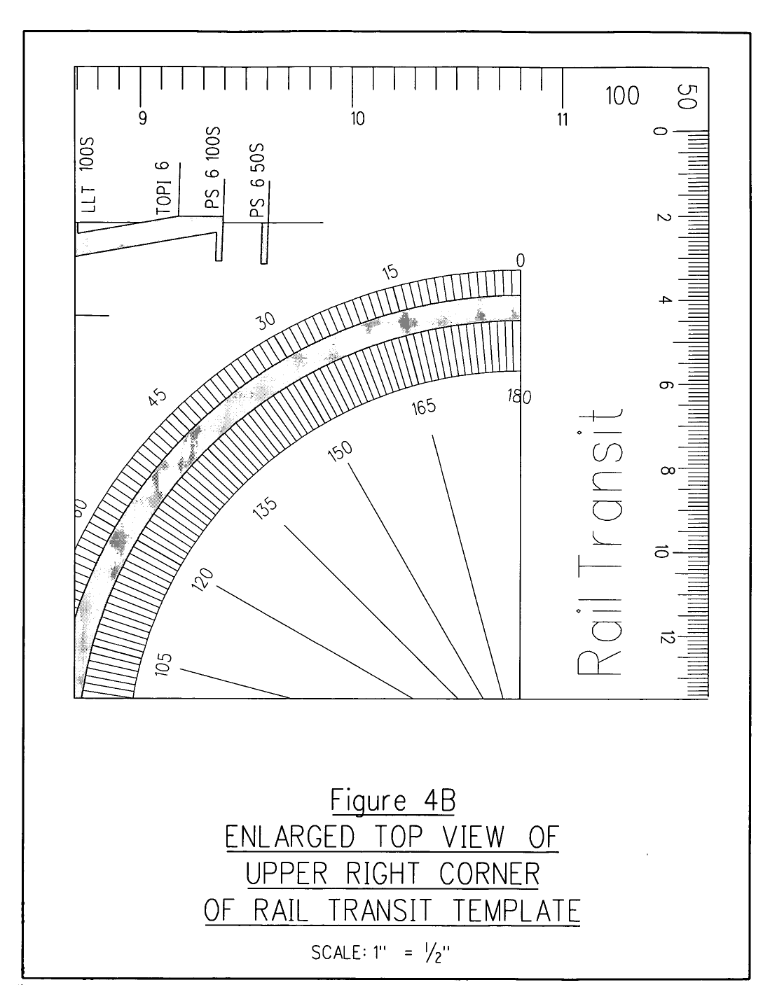

FIG. 4C is an enlargement of the lower left corner of the top view of the Trak-Edge R/T template. The scale is 1 inch on the drawing=½ inches on the actual template.

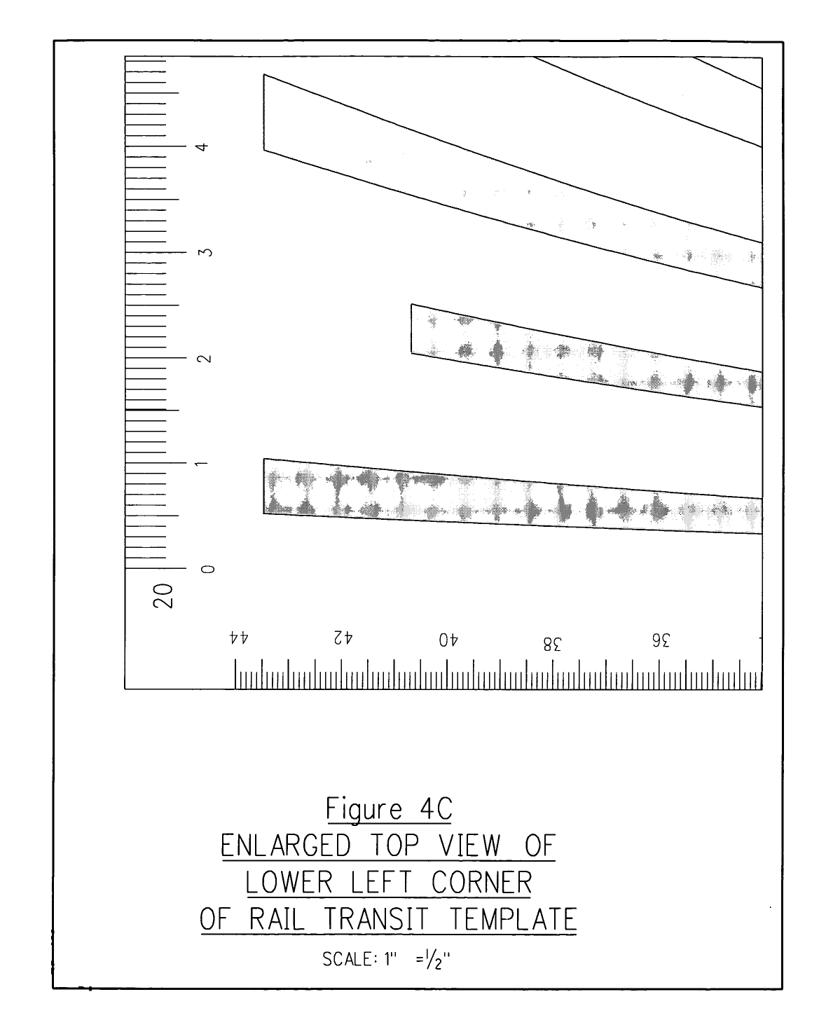

FIG. 4D is an enlargement of the lower right corner of the top view of the Trak-Edge R/T template. The scale is 1 inch on the drawing=½ inches on the actual template.

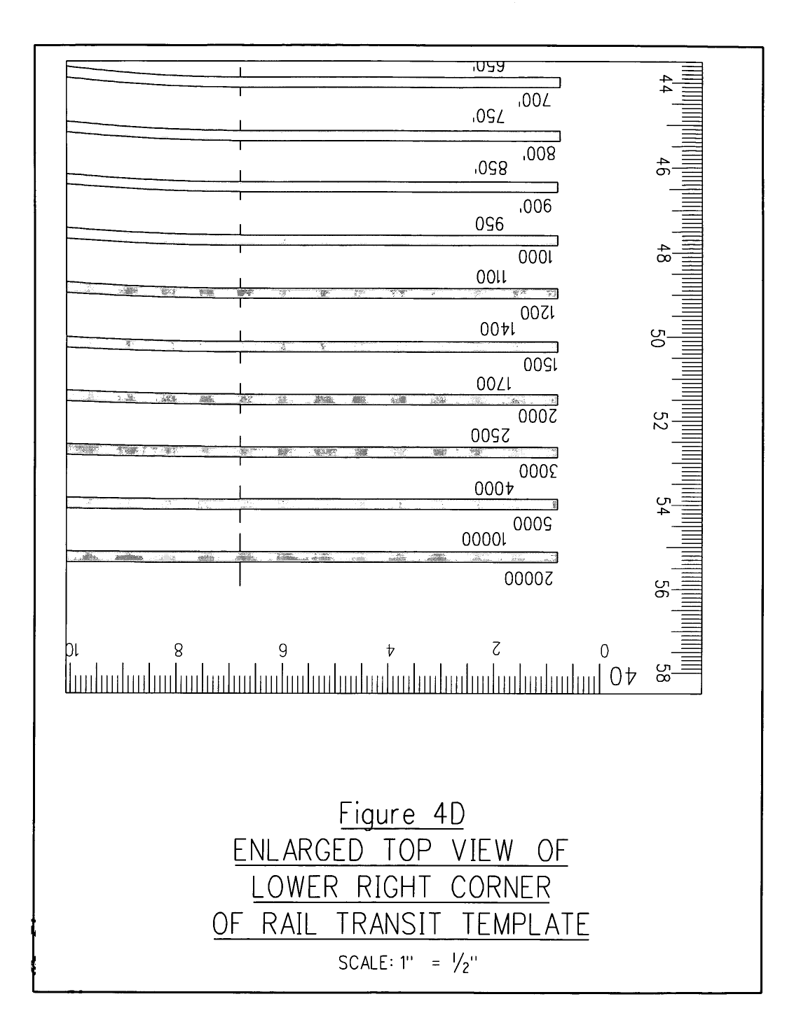

FIG. 5 shows the bottom view of the Trak-Edge R/T template without text. The drawing is reduced such that the scale is 1 inch on the drawing=2 inches on the actual template. FIG. 5 also is the Key Plan that explains the orientation of FIGS. 5A, 5B, 5C and 5D.

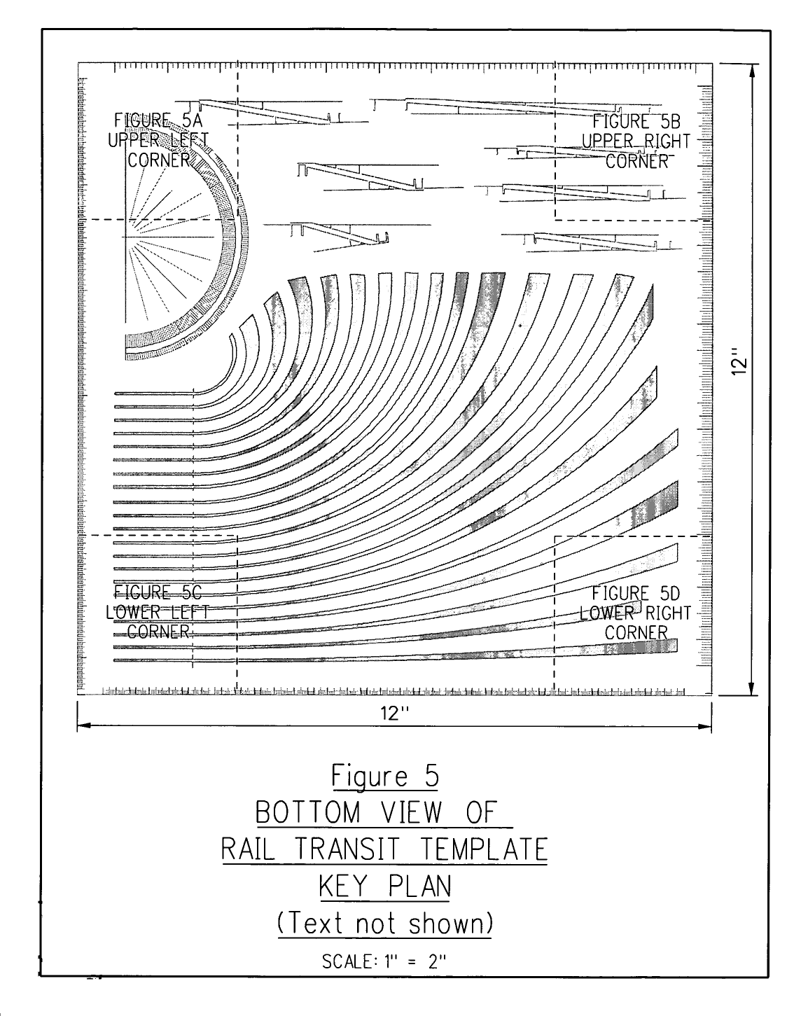

FIG. 5A is an enlargement of the upper left corner of the bottom view of the Trak-Edge R/T template. The scale is 1 inch on the drawing=½ inches on the actual template.

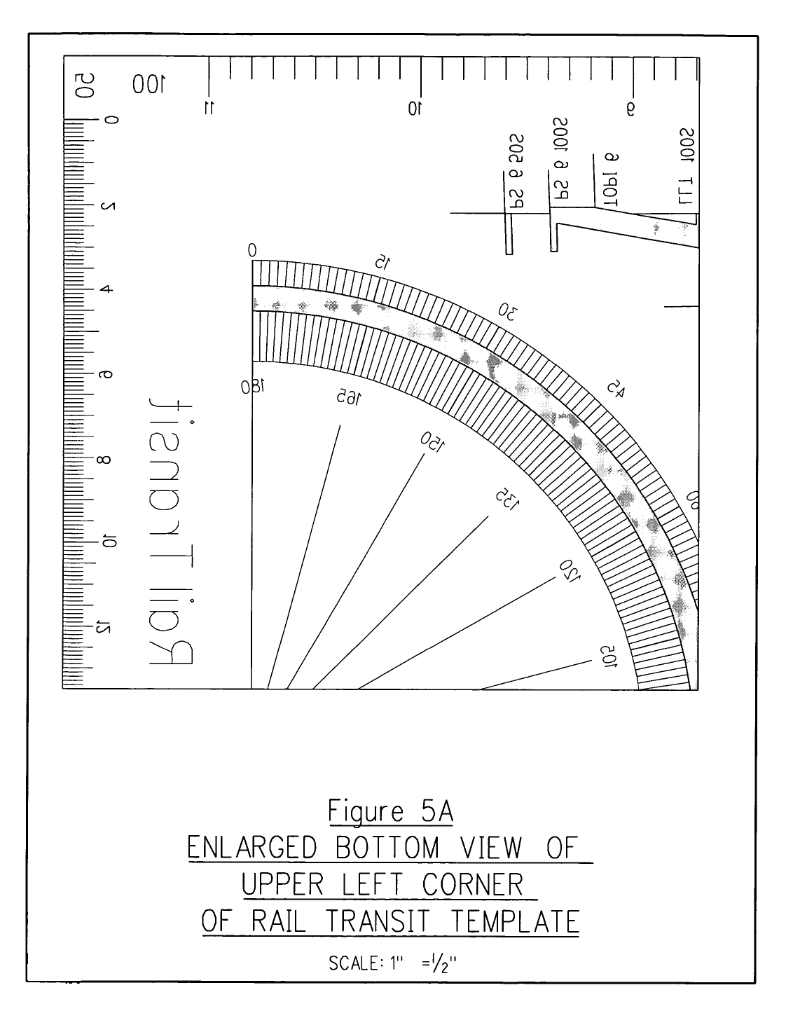

FIG. 5B is an enlargement of the upper right corner of the bottom view of the Trak-Edge R/T template. The scale is 1 inch on the drawing=½ inches on the actual template.

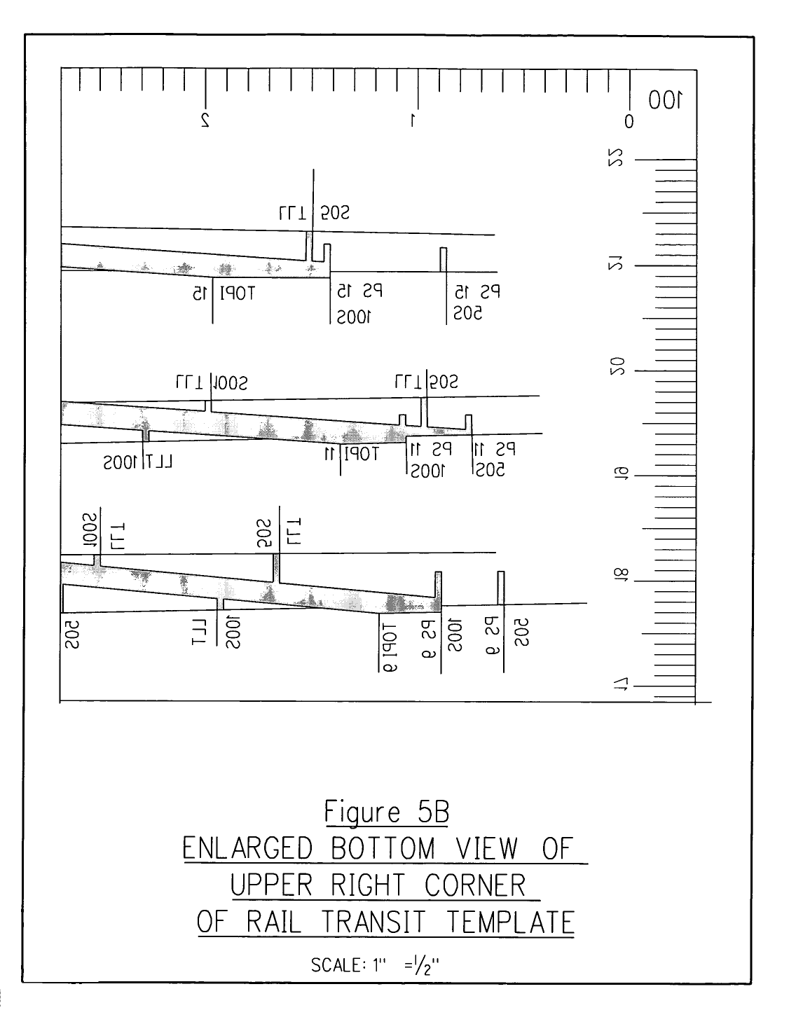

FIG. 5C is an enlargement of the lower left corner of the bottom view of the Trak-Edge R/T template. The scale is 1 inch on the drawing=½ inches on the actual template.

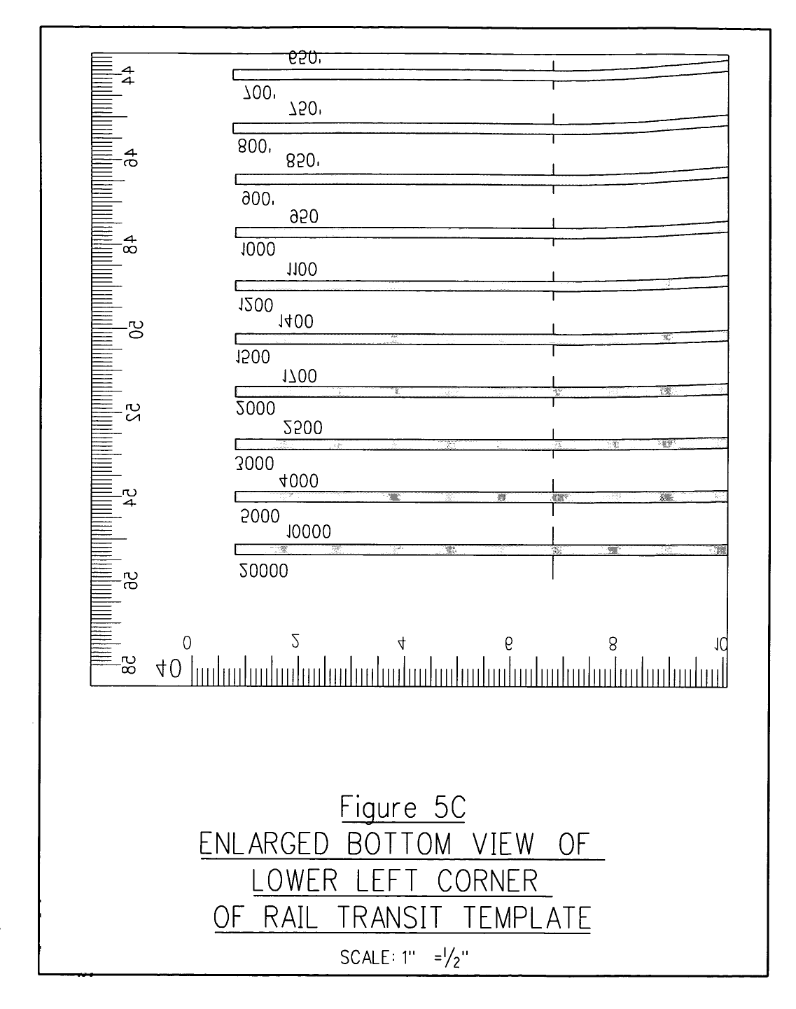

FIG. 5D is an enlargement of the lower right corner of the bottom view of the Trak-Edge R/T template. The scale is 1 inch on the drawing=½ inches on the actual template.

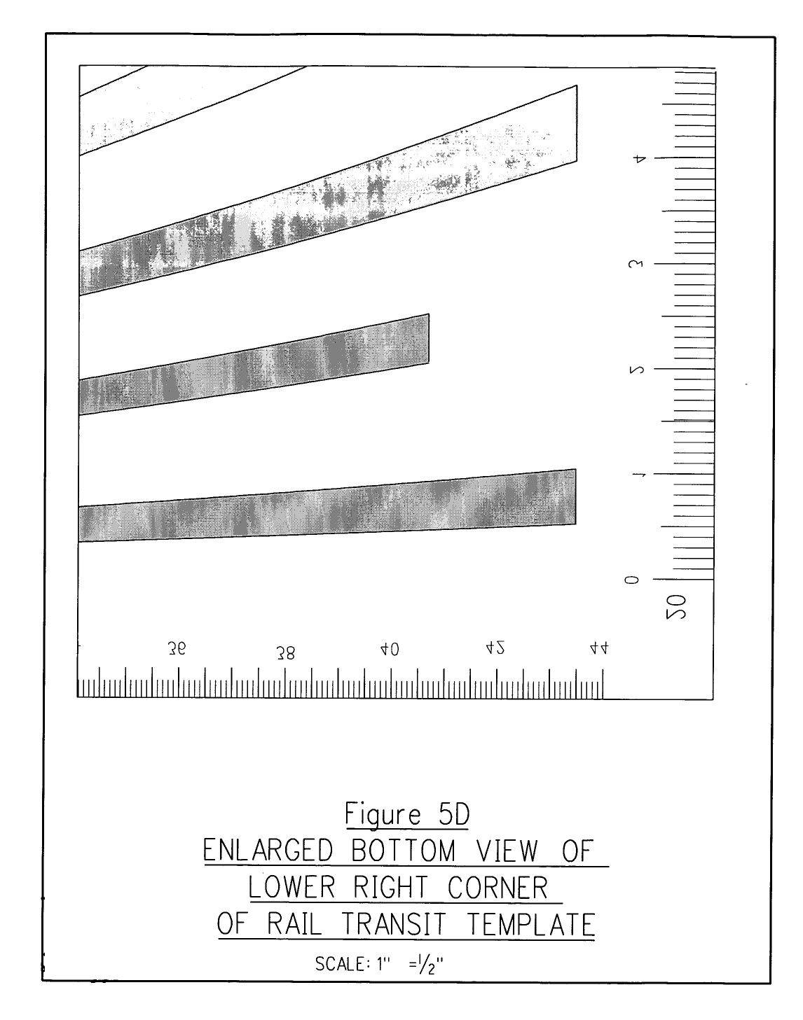

The shaded areas in the templates indicate areas that are “cut out” or open to allow a pencil to ride against the edge to generate the desired line. Both of these templates will be manufactured from see-through, flexible plastic and are approximately 0.03 inch thick.

### DETAILED DESCRIPTION OF THE INVENTION

The Trak-Edge F/P template is a 12-inch square design aid that facilitates the drawing of centerline of track through turnouts and along curves and tangents during the conceptual or preliminary design of freight and passenger track alignments. The open or “cut out” areas in the plastic template are shaded in gray. The designer may use the template in combination with an existing set of drawings or a new survey. Various size turnouts from a #8 to a #32.7 are depicted on the Trak-Edge F/P template using their specific frog angles. A proposed turnout is typically installed in an existing section of tangent or straight track. The existing straight track where the straight side of the proposed turnout will be located is shown as a solid line. The diverging side of the proposed turnout can be accurately drawn through the slanted slot from the turnout point-of-intersection (TOPI). Curves of varying degree of curvature are depicted on the Trak-Edge F/P template in 15-minute increments.

The Trak-Edge R/T template is a 12-inch square design aid that facilitates the drawing of centerline of track through turnouts and along curves and tangents during the conceptual design of light rail and transit track alignments. The open areas in the plastic template are shaded in gray. The designer may use the template in combination with an existing set of drawings or a new survey. Various size turnouts from a 25-meter to a #20 are depicted on the Trak-Edge R/T template using their specific frog angles. The existing straight track where the straight side of the proposed turnout will be located is shown as a solid line. The diverging side of the proposed turnout can be accurately drawn through the slanted slot from the turnout point-of-intersection (TOPI). Various curves in 100 scale from 20,000 foot radius to 75 foot radius are depicted on the Trak-Edge R/T template.

The appropriate size turnout in track design is selected based on the desired train speed through the diverging side of the turnout. A track designer positions the Trak-Edge template so that the straight side of the proposed turnout, represented by a solid line on template, is aligned over the centerline of the existing track shown on the drawing. A 0.02-inch notch is recessed into the template so that the designer's pencil can travel exactly over the centerline of the existing track. The physical edge of the slanted slot is also recessed 0.02-inch from the true track centerline of the diverging side of the proposed turnout. This 0.02-inch recess enables the designer to accurately draw the centerline of the proposed diverging side of the turnout at the precise frog angle from the TOPI (turnout point-of-intersection) location. The TOPI location of the proposed turnout is depicted as a perpendicular solid line from the straight side where the slanted slot intersects with the notch.

The point of switch (PS) and last-long-tie (LLT) locations are also provided as slots for the various size turnouts in the popular 50 and 100 scales. This enables the track designer to quickly indicate the beginning and end of the proposed turnout on his drawing.

Scales of 100, 50, 40 and 20 are provided on the four edges of the Trak-Edge templates to facilitate track design in these popular design scales. The front face of the Trak-Edge templates provides left-hand turnouts and right-hand curves. The rear face of the Trak-Edge templates provides right-hand turnouts and left-hand curves. By spinning and flipping the Trak-Edge templates in the hands of an experienced track designer will enable him to use the combination of turnout and curve geometry design aids to quickly plan and develop accurate conceptual track layouts and preliminary alignments for subsequent intelligent design using CAD software.

The Trak-Edge templates are only 12 inches square, weighs less than an ounce and is therefore fully mobile in a brief case. Preliminary track layouts can readily be developed on a set of existing drawings in a construction field trailer, on the hood of a truck or in an engineering design office. The Trak-Edge templates will facilitate the development of accurate conceptual track layouts and preliminary alignments without bulky and expensive CAD equipment or lengthy CAD training. The Trak-Edge templates places the conceptual track design effort back into the hands of the seasoned track designer who will then be able to guide the CAD technicians to finalize the design based on his experience, i.e. “Please make sure it looks like this when your finished.”

What I claim in my invention is:

I. My railroad design templates depict a turnout of a given size by its exact frog angle so that the centerline of the diverging side of the turnout can be accurately drawn from the turnout point of intersection (TOPI). Therefore, my railroad design templates overcome the problems of approximating the curvature of proposed turnouts on track design drawings using curve boards. The depiction of a turnout of a given size by its exact frog angle on a template has never been done before.

II. My railroad design templates provide a 0.02-inch recess so that the designer's pencil can travel exactly over the centerline of the existing track. The physical edge of the slanted slot is also recessed 0.02-inch from the true track centerline of the diverging side of the proposed turnout. This 0.02-inch recess enables the designer to accurately draw the centerline of the proposed diverging side of the turnout at the precise frog angle from the TOPI (turnout point-of-intersection) location. This usage of the 0.02-inch recess to accurately draw the centerline of the proposed diverging side of the turnout at the precise frog angle on a template has never been done before.

III. My railroad design templates combine all the various size curves, various size turnouts, various scales and protractor all on one template. This combination of design features has never been done before. This unique combination of various size curves, various size turnouts, various scales and protractor all on one template will allow track designers to conveniently develop track alignments.

IV. My railroad design templates also allow the track designer to indicate the point of switch (PS) and last-long-tie (LLT) locations on his drawings. I believe the depiction of the point of switch and last-long-tie locations of a turnout via a template has never been done before.
